(19) United States
(12) Patent Application Publication
(10) Pub. No.: US 2025/0372117 A1
(43) Pub. Date: Dec. 4, 2025

(54) ELECTRONIC DEVICE AND OPERATING METHOD THEREOF, AND STORAGE MEDIUM

(71) Applicant: SAMSUNG ELECTRONICS CO., LTD., Suwon-si (KR)

(72) Inventors: Jaemo YANG, Suwon-si (KR); Hangil MOON, Suwon-si (KR); Kyoungho BANG, Suwon-si (KR); Moa LEE, Suwon-si (KR); Jeonghwan CHOI, Suwon-si (KR); Brian HAN, Suwon-si (KR)

(73) Assignee: SAMSUNG ELECTRONICS CO., LTD., Suwon-si (KR)

(21) Appl. No.: 19/176,572

(22) Filed: Apr. 11, 2025

Related U.S. Application Data
(63) Continuation of application No. PCT/KR2025/095153, filed on Apr. 1, 2025.

(30) Foreign Application Priority Data
May 28, 2024 (KR) 10-2024-0069380
Jun. 11, 2024 (KR) 10-2024-0075907

(51) Int. Cl. G10L 25/51; G06F 9/451

(52) U.S. Cl. CPC G10L 25/51; G06F 9/451

(57) ABSTRACT

An electronic device includes memory storing instructions; and at least one processor; wherein the instructions, when executed by the at least one processor, cause the electronic device to identify a first audio signal including a first plurality of audio sources; identify a first audio source, corresponding to at least one first type, from the first audio signal; based on at least one configuration value corresponding to each of the at least one first type, perform signal processing on the first audio source; generate a second audio signal based on at least a portion of a remaining signal of the first audio signal excluding the first audio source, and the signal-processed first audio source; and output the second audio signal.

### CROSS-REFERENCE TO RELATED APPLICATIONS

This application is a by-pass continuation application of International Application No. PCT/KR2025/095153, filed on Apr. 1, 2025, which is based on and claims priority to Korean Patent Application No. 10-2024-0069380, filed in the Korean Intellectual Property Office on May 28, 2024, and Korean Patent Application No. 10-2024-0075907, filed in the Korean Intellectual Property Office on Jun. 11, 2024, the disclosures of which are incorporated by reference herein in their entireties.

### BACKGROUND

### 1. Field

Embodiments of the disclosure relate to an electronic device for processing sounds, a method of operating the same, and a storage medium.

### 2. Description of Related Art

Various services and additional functions provided through electronic devices, for example, portable electronic devices such as smartphones have gradually increased. In order to increase the effective value of such electronic devices and satisfy various user needs, communication service providers or electronic device manufacturers have provided various functions and competitively developed electronic devices that are differentiated from those of other companies. Accordingly, various functions provided through electronic devices have gradually advanced. With the development of sound processing technology (sound separation and mixing technology), a method of increasing user's satisfaction by efficiently separating and combining sounds is needed.

The above-described information may be provided as related art for the purpose of assisting in understanding the disclosure. No assertion or decision is made as to whether any of the above might be applicable as prior art with regard to the disclosure.

### SUMMARY

According to an aspect of the disclosure, an electronic device includes memory storing instructions; at least one processor; wherein the instructions, when executed by the at least one processor, cause the electronic device to identify a first audio signal including a plurality of audio sources; identify a first audio source, corresponding to at least one type, from the first audio signal; based on at least one configuration value corresponding to each of the at least one type, perform signal processing on the first audio source; generate a second audio signal based on at least a portion of a remaining signal of the first audio signal excluding the first audio source, and the signal-processed first audio source; and output the second audio signal.

According to an aspect of the disclosure, a method of operating an electronic device includes identifying a first audio signal including a plurality of audio sources; identifying a first audio source corresponding to at least one first type from the first audio signal; based on at least one configuration value corresponding to each of the at least one type, performing signal processing on the first audio source; generating a second audio signal based on at least a portion of a remaining signal of the first audio signal, excluding the first audio source, and the signal-processed first audio source; and outputting the second audio signal.

According to an aspect of the disclosure, a non-transitory computer readable medium storing instructions that, when executed by at least one processor of an electronic device, causes the electronic device to identify a first audio signal including a plurality of audio sources; identify a first audio source, corresponding to at least one type, from the first audio signal; based on at least one configuration value corresponding to each of the at least one type, perform signal processing on the first audio source; generate a second audio signal based on at least a portion of a remaining signal of the first audio signal excluding the first audio source, and the signal-processed first audio source; and output the second audio signal.

### BRIEF DESCRIPTION OF THE DRAWINGS

With regard to the description of the drawings, the same or like reference signs may be used to designate the same or like elements.

The above and other aspects, features, and advantages of certain embodiments of the present disclosure are more apparent from the following description taken in conjunction with the accompanying drawings, in which:

FIG. 1 is a block diagram of an electronic device in a network environment according to an embodiment.

FIG. 2 is a block diagram illustrating elements of an electronic device according to an embodiment.

FIG. 3 is a flowchart illustrating a method of operating the electronic device according to an embodiment.

FIG. 4 is a flowchart illustrating a method of identifying types corresponding to audio sources according to an embodiment.

FIG. 5 is a flowchart illustrating a method of providing a second audio signal according to an embodiment.

FIG. 6 is a flowchart illustrating a method of signal-processing a first audio signal according to an embodiment.

FIG. 7 is a flowchart illustrating a method of identifying the remaining signal according to an embodiment.

FIG. 8 illustrates a second artificial intelligence model according to an embodiment.

FIG. 9 illustrates a method of providing a user interface (UI) according to an embodiment.

FIG. 10 is a flowchart illustrating a method of identifying a weight according to an embodiment.

FIG. 11 is a flowchart illustrating a method of identifying a weight according to an embodiment.

FIG. 12 is a flowchart illustrating a method of identifying a weight according to an embodiment.

FIG. 13A illustrates a first artificial intelligence model and a third artificial intelligence model according to an embodiment.

FIG. 13B illustrates a method of identifying a second audio signal according to an embodiment.

FIG. 14 illustrates an implementation example of a first artificial intelligence model according to an embodiment.

FIG. 15 illustrates an implementation example of a first artificial intelligence model according to an embodiment.

FIG. 16 illustrates an implementation example of a third artificial intelligence model according to an embodiment.

FIG. 17 illustrates a fifth artificial intelligence model according to an embodiment.

FIGS. 18A, 18B, and 18C illustrate filters according to an embodiment.

### DETAILED DESCRIPTION

Hereinafter, embodiments of the disclosure will be described in detail with reference to the drawings so that those skilled in the art to which the disclosure pertains can implement the disclosure. However, the disclosure may be implemented in various forms and is not limited to embodiments set forth herein. With regard to the description of the drawings, the same or like reference signs may be used to designate the same or like elements.

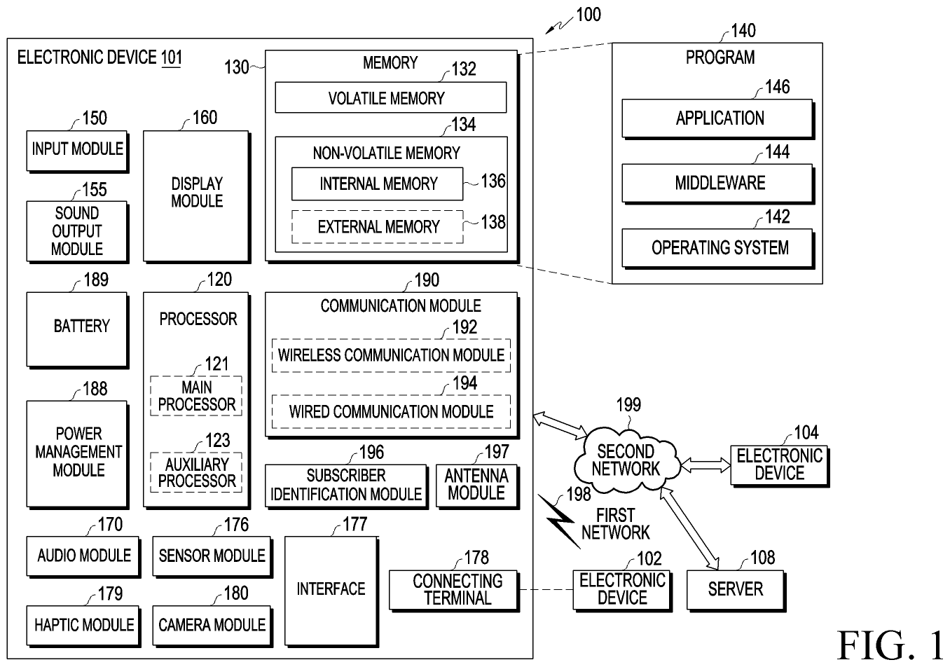

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

In the following detailed description, the same reference numeral may be assigned to elements that can be understood through prior embodiments. An electronic device according to an embodiment disclosed in this document may be implemented through a selective combination of elements of different embodiments, and an element of one embodiment may be replaced with an element of another embodiment. For example, it should be noted that the disclosure is not limited to specific drawings or embodiments.

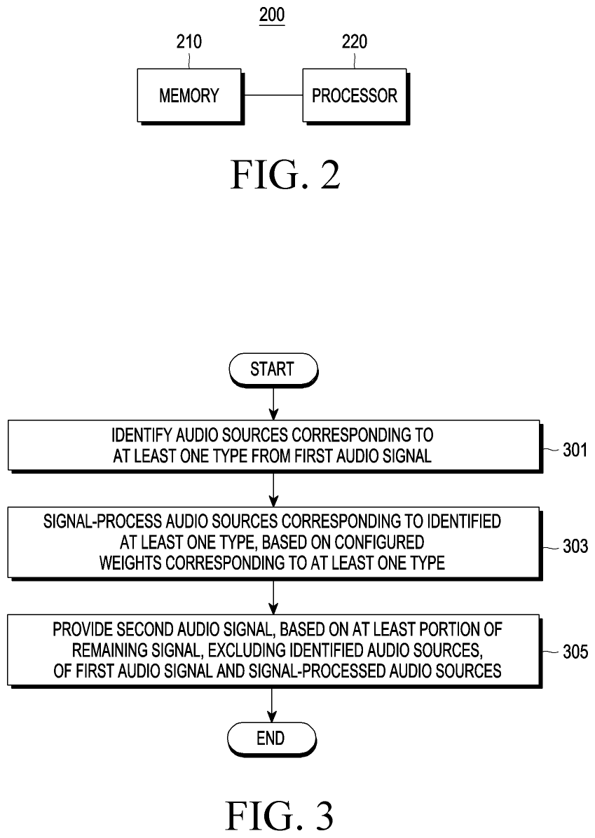

FIG. 2 is a block diagram illustrating elements of an electronic device according to an embodiment.

According to FIG. 2, according to an embodiment, an electronic device 200 (for example, the electronic device 101 of FIG. 1) may include memory 210 (for example, the memory 130 of FIG. 1) configured to store instructions and at least one processor 220 (or the processor 120 of FIG. 1).

According to an embodiment, the memory 210 may be an element which is at least partially the same as or similar to the memory 130 of FIG. 1. For example, the memory 210 is to temporarily or permanently store digital data and may include at least some of the configurations and/or the functions of the memory 130 of FIG. 1.

The memory 210 according to an embodiment may store various instructions that can be executed by at least one processor 220. The memory 210 may store at least some of the programs 140 of FIG. 1. The instructions may include control commands such as logical operations and data input and outputs that can be recognized and performed by the processor 220. There is no limitation on the type and/or the amount of data which the memory 210 can store, but this document describes a method of identifying user commands according to various embodiments, and configurations and functions of memory related to the operation of the processor 220 which performs the method. The memory 210 may store various pieces of information, and the various pieces of information stored in the memory 210 will be described below in detail.

According to an embodiment, at least one processor 220 (hereinafter, referred to as the processor) may be an element which is at least partially the same as or similar to the processor 120 of FIG. 1. According to an embodiment, the processor 220 may include one or more processors.

According to an embodiment, the processor 220 may execute instructions stored in the memory 210 to perform various operations.

According to an embodiment, the processor 220 may identify audio sources corresponding to at least one type from a first audio signal including a plurality of audio sources. According to an embodiment, at least one type may include various types including a speech type, a music type, an alarm type, or a siren type. According to an embodiment, the first audio signal may include a plurality of audio sources. According to an embodiment, the processor 220 may identify audio sources corresponding to at least one type among the plurality of audio sources included in the first audio signal. According to an embodiment, the first audio signal may include audio sources corresponding to at least one type and the remaining signal (or non-classified signal or non-identified signal) excluding the identified audio sources.

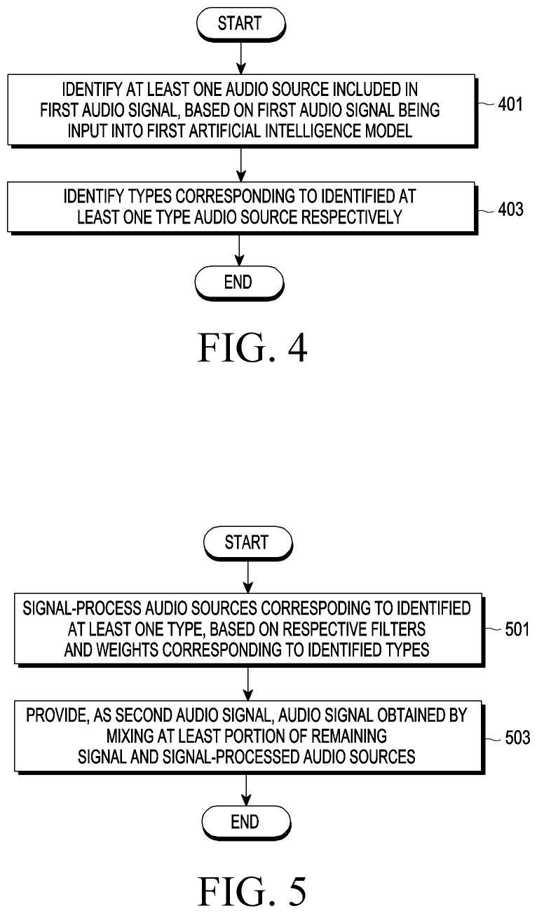

According to an embodiment, the processor 220 may identify at least one audio source from the first audio signal. According to an embodiment, the audio sources corresponding to at least one type may include features corresponding to each type (for example, a waveform, a main frequency band, or the like), and the processor 220 may identify at least one audio source, based thereon. According to an embodiment, the processor 220 may identify at least one audio source from the first audio signal by using a designated sound source separation algorithm. According to an embodiment, the processor 220 may identify at least one audio source from the first audio signal by using an artificial intelligence model. This will be described in detail with reference to FIG. 4.

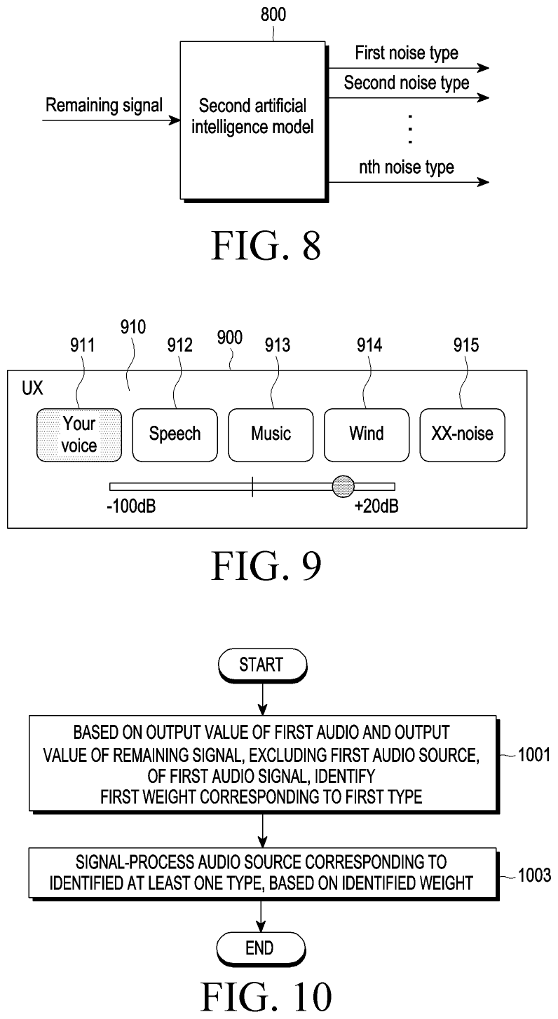

According to an embodiment, when at least one audio source is identified, the processor 220 may identify a type corresponding to each of the identified audio sources. For example, the processor 220 may identify types of at least one audio sources by using an artificial intelligence model capable of classifying types corresponding to input audio sources. This will be described in detail with reference to FIGS. 4 and 8.

According to an embodiment, the processor 220 may signal-process the audio sources corresponding to the identified at least one type, based on configuration values corresponding to at least one type. According to an example, the configuration value may include at least one of weight configuration values (or weights) corresponding to at least one type and filter configuration values corresponding to at least one type. According to an example, when an audio source (or a first audio source) corresponding to a first type and an audio source (or a second audio source) corresponding to a second type are identified from the first audio signal, the processor 220 may apply a first weight corresponding to the first type to the audio source corresponding to the first type and apply a second weight corresponding to the second type to the audio source corresponding to the second type, so as to acquire the signal-processed audio sources. In embodiments described below, identifying two types of audio sources is described by way of example, but the disclosure is not limited thereto and three or more types of audio sources may be identified.

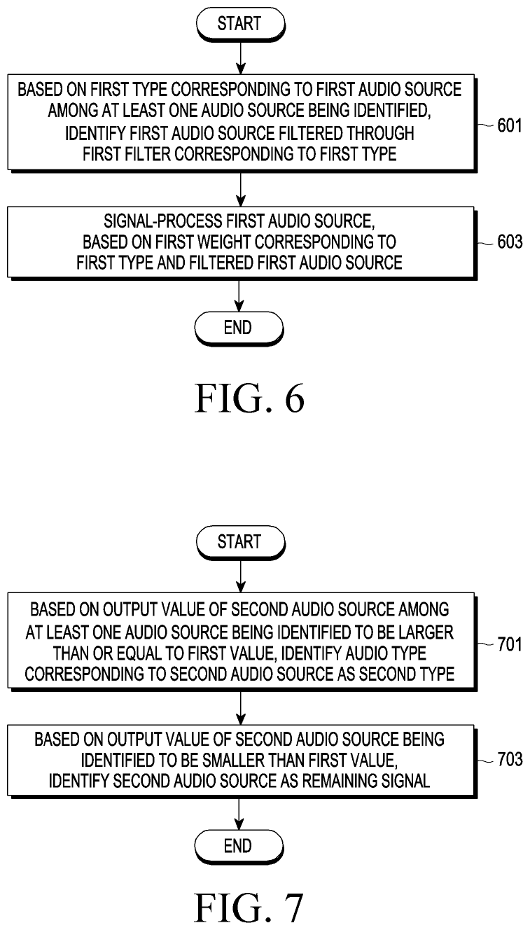

According to an embodiment, the processor 220 may signal-process audio sources by using filters (or filter configuration values) corresponding to at least one type. For example, when the audio source corresponding to the first type is identified, the processor 220 may filter the audio source corresponding to the first type through a filter corresponding to the first type. According to an embodiment, there may be a main frequency band corresponding to each audio type including a music type or a speech type, and a filter corresponding to a type may filter a signal of the main frequency band corresponding to the type and provide an audio signal having the improved sound quality. This will be described in detail with reference to FIGS. 5 and 6.

According to an embodiment, the processor 220 may provide a second audio signal, based on at least a portion of the remaining signal, excluding the identified at least one audio source, of the first audio signal and the signal-processed audio sources. According to an embodiment, it may be assumed that the audio source corresponding to the first type and the audio source corresponding to the second type are identified from the first audio signal. According to an embodiment, the processor 220 may identify the remaining signal, excluding the audio source corresponding to the first type and the audio source corresponding to the second type, of the first audio signal. According to an embodiment, the processor 220 may generate, output, or identify the second audio signal by mixing the audio signals to which the configuration values are applied and at least a portion of the remaining signal. According to an embodiment, the processor 220 may signal-process the remaining signal by using a configuration value corresponding to the remaining signal. According to an embodiment, the processor 220 may generate, output, or identify the second audio signal by mixing at least a portion of the signal-processed remaining signal and the signal-processed audio sources.

FIG. 3 is a flowchart illustrating a method of operating the electronic device according to an embodiment.

Referring to FIG. 3, according to an embodiment, the operation method may identify audio sources corresponding to at least one type from a first audio signal including a plurality of audio sources in operation 301. According to an embodiment, an electronic device (for example, the electronic device 200 of FIG. 2) may identify an audio source corresponding to a first type and an audio source corresponding to a second type from the first audio signal by using a designated sound source separation algorithm or artificial intelligence model. According to an embodiment, the electronic device may identify the remaining signal along with the audio source corresponding to the first type and the audio source corresponding to the second type.

According to an embodiment, the operation method may signal-process audio sources corresponding to the identified at least one type, based on configuration values (e.g. weights) corresponding to the identified at least one type in operation 303. According to an embodiment, the electronic device may signal-process the audio sources, based on at least one of a weight corresponding to the first type or a filter configuration value corresponding to the first type as a configuration value corresponding to the audio source corresponding to the first type. According to an embodiment, when the audio source corresponding to the first type is identified from the first audio signal, the electronic device may signal-process the audio source corresponding to the first type by using the weight corresponding to the identified first type and the filter corresponding to the first type. For example, when the audio source corresponding to the second type is identified, the electronic device may signal-process the audio source corresponding to the second type by using the weight corresponding to the identified second type and the filter corresponding to the second type.

According to an embodiment, the operation method may provide a second audio signal, based on at least a portion of the remaining signal, excluding the identified audio sources, of the first audio signal and the signal-processed audio sources in operation 305. According to an embodiment, the electronic device may identify the remaining signal, excluding the audio source corresponding to the first type and the audio source corresponding to the second type, of the first audio signal. According to an embodiment, the electronic device may generate, output, or identify the second audio signal by mixing the signal-processed audio source corresponding to the first type and the signal-processed audio source corresponding to the second type, and the remaining signal. According to an embodiment, the electronic device may generate, output, or identify the second audio signal by using only at least a portion of the remaining signal.

According to the above-described example, the electronic device may improve the sound quality of the existing audio signal and reduce sound loss during an audio source mixing process by signal-processing audio sources corresponding to predetermined types and mixing the signal-processed signal and the remaining signal.

FIG. 4 is a flowchart illustrating a method of identifying types corresponding to audio sources according to an embodiment.

Referring to FIG. 4, according to an embodiment, in operation 401, the operation method may identify at least audio source included in a first audio signal (for example, the first audio signal of FIG. 3), based on the first audio signal being input into a first artificial intelligence model.

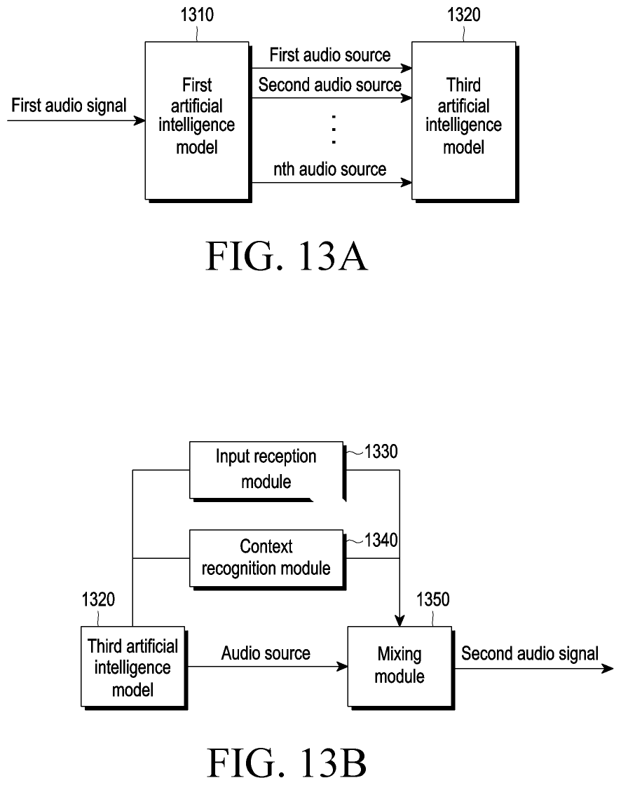

According to an embodiment, the first artificial intelligence model may be an artificial intelligence model trained to separate at least one audio source included in an audio signal. According to an embodiment, the first artificial intelligence model may be a model constituted by an artificial neural network. For example, the first artificial intelligence model may be a model implemented by a deep neural network (DNN). According to an embodiment, the first artificial intelligence model may be a model trained such that a sum of an output value of the remaining signal and output values of at least one audio source is the same as or similar to an output value of the first audio signal. According to an embodiment, the first artificial intelligence model may be a model trained to maintain the input audio signal and a sum of at least one output audio source and the remaining signal. The first artificial intelligence model is described in detail with reference to FIGS. 13A, 14, and 15.

According to an embodiment, an electronic device (for example, the electronic device 200 of FIG. 2) may input a first audio signal into a first artificial intelligence model and identify at least one audio source and the remaining signal excluding at least one audio source.

According to an embodiment, in operation 403, the operation method may identify each type (for example, the type of FIG. 3) corresponding to each of the identified audio source. According to an embodiment, the electronic device may identify each of the types for at least one audio source included in the first audio signal. For example, the electronic device may identify a first audio source included in the first audio signal as a first type (for example, a music type). For example, the electronic device may identify a second audio source included in the first audio signal as a second type (for example, a speech type). According to an embodiment, the electronic device may identify audio sources, which are not identified as designated types, as the remaining signal. This will be described in detail with reference to FIG. 7.

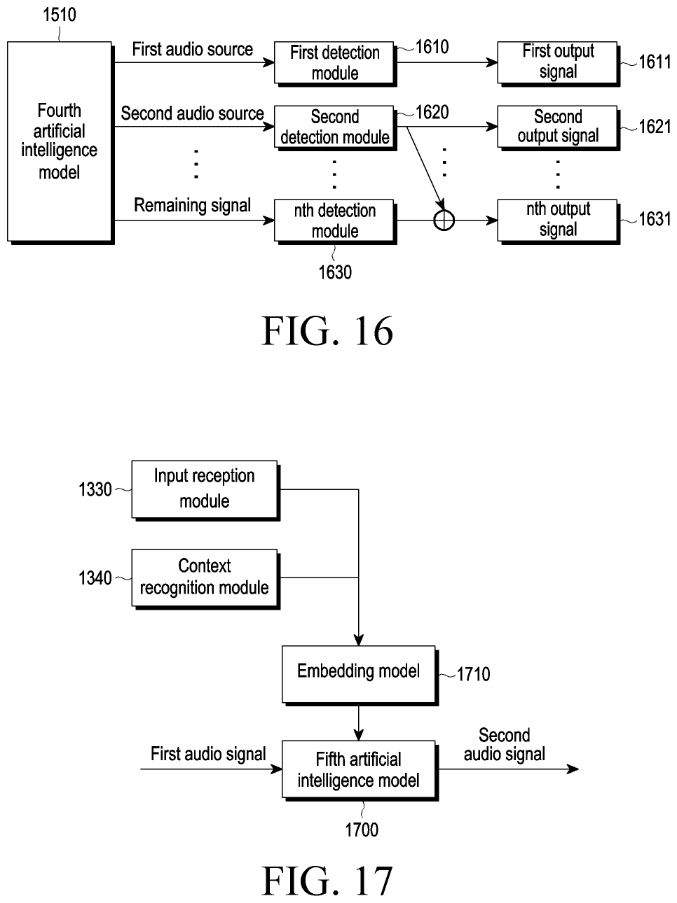

According to an embodiment, the electronic device may identify types corresponding to at least one audio source by using a third artificial intelligence model trained to classify types of the input audio sources. According to an embodiment, the third artificial intelligence model may be implemented as a classifier. For example, the third artificial intelligence model may be implemented as a DNN. According to an embodiment, the third artificial intelligence model may be implemented using support vector machine (SVM) or various types of algorithms including a linear regression algorithm. The third artificial intelligence model will be described in detail with reference to FIGS. 13A and 16.

FIG. 5 is a flowchart illustrating a method of providing a second audio signal according to an embodiment.

Referring to FIG. 5, according to an embodiment, in operation 501, the operation method may signal-process audio sources (for example, the audio sources of FIG. 3) corresponding to the identified at least one type, based on filters) and weights (for example, the weights of FIG. 3) corresponding to the identified types (for example, the types of FIG. 4).

According to an embodiment, the filters corresponding to the identified types may be filters capable of filtering signals of main frequency bands corresponding to the identified type. According to an embodiment, the weights corresponding to the identified types may be values configured based on a signal-to-noise ratio (SNR) corresponding to the audio source. According to an embodiment, the weight may be acquired based on a user input or may be acquired based on video content corresponding to first audio. A method of identifying the weight will be described in detail with reference to FIGS. 10 to 12.

According to an embodiment, when a first audio source of a first type included in a first audio signal is identified, an electronic device (for example, the electronic device 200 of FIG. 2) may filter the first audio source through a filter corresponding to the first type and apply a weight corresponding to the first type to the filtered first audio source, so as to signal-process the first audio source. This will be described in detail with reference to FIG. 6.

According to an embodiment, in operation 503, the operation method may provide an audio signal obtained by mixing at least a portion of the remaining signal (for example, the remaining signal of FIG. 3) and the signal-processed audio sources to a second audio signal (for example, the second audio signal of FIG. 3). According to an embodiment, the electronic device may identify, as the remaining signal, the signal, excluding the audio sources of the identified at least one type, of the first audio signal.

According to an embodiment, the electronic device may generate, output, or identify the second audio signal by mixing the signal-processed audio sources and at least the portion of the remaining signal. For example, the electronic device may mix the signal-processed audio sources and the remaining signal to generate, output, or identify the second audio signal which makes the output loss that may be generated through separation of the first audio signal minimum. However, the disclosure is not limited thereto and, for example, the electronic device may generate, output, or identify the second audio signal by using only the portion of the remaining signal.

FIG. 6 is a flowchart illustrating a method of signal-processing a first audio signal according to an embodiment.

Referring to FIG. 6, according to an embodiment, the operation method may identify a first audio source filtered through a first filter corresponding to a first type, based on the first type corresponding to the first audio source being identified among at least one audio source (for example, the at least one audio source of FIG. 4) in operation 601.

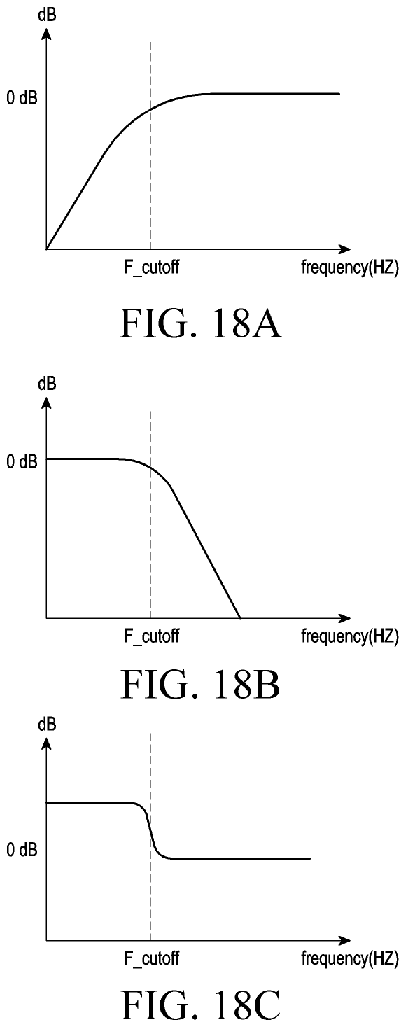

According to an embodiment, an electronic device (for example, the electronic device 200 of FIG. 2) may identify the first type as a type corresponding to the first audio source through a third artificial intelligence model (for example, the third artificial intelligence model of FIG. 4). According to an embodiment, the electronic device may filter the first audio source by using the first filter corresponding to the first type. For example, when the first type is a music type, the first filter may filter the first audio signal to increase a proportion of the signal of the main frequency band corresponding to the audio signal of the music type. The filter will be described in detail with reference to FIGS. 18A to 18C.

According to an embodiment, the operation method may signal-process the first audio source, based on a first weight corresponding to the first type and the filtered first audio source.

According to an embodiment, when filtering of the first audio source is performed, the electronic device may signal-process the first audio source by multiplying the filtered first audio source and the configured first weight. For example, the electronic device may acquire the first weight, based on a user input. The electronic device may identify the proportion of the first audio source (or the SNR value corresponding to the first audio source) in the first audio signal as the first weight. The electronic device may signal-process the first audio source by multiplying the first weight and the filtered first audio source. For example, the electronic device may identify a second audio signal (for example, the second audio signal of FIG. 3), based on the signal-processed first audio source.

FIG. 7 is a flowchart illustrating a method of identifying the remaining signal according to an embodiment.

Referring to FIG. 7, according to an embodiment, the operation method may identify, as a second type, an audio type (for example, the type of FIG. 6) corresponding to a second audio source, based on an output value of the second audio source being identified to be larger than or equal to a first value among at least one audio source (for example, at least one audio source of FIG. 6) in operation 701.

According to an embodiment, an electronic device (For example, the electronic device 200 of FIG. 2) may input a first audio signal into a first artificial intelligence model (for example, the first artificial intelligence model of FIG. 4) and identify at least one audio source and the remaining signal excluding the at least one audio source. According to an embodiment, the electronic device may compare an output value of a second audio source among the at least one audio source with the first value and identify whether the output value of the second audio source is larger than or equal to the first value. When it is identified that the output value of the second audio source is larger than or equal to the first value, the electronic device may identify an audio type corresponding to the second audio source as a second type.

According to an embodiment, the electronic device may input the second audio source into a third artificial intelligence model (for example, the third artificial intelligence model of FIGS. 13A-13B) and identify an audio type corresponding to the second audio source as the second type. According to an embodiment, the third artificial intelligence model may be a model trained to output a type corresponding to an audio source. According to an embodiment, when the input audio source is classified as an audio source of a type, the third artificial intelligence model may identify the input audio source as an audio source corresponding to the type if an output value of the input audio source is larger than or equal to a predetermined value.

According to an embodiment, the operation method may identify the second audio source as the remaining signal (for example, the remaining signal of FIG. 3), based on the output value of the second audio source being identified to be smaller than the first value. According to an embodiment, the electronic device may compare the output value of the second audio source among the at least one audio source with the first value and identify whether the output value of the second audio source is smaller than the first value. According to an embodiment, the electronic device may identify, as the remaining signal, audio sources smaller than the predetermined output value, separately from the remaining signal output through the first artificial intelligence model.

According to an embodiment, the electronic device may input the second audio source into the third artificial intelligence model (for example, the third artificial intelligence model of FIGS. 13A-13B) and identify the second audio source as the remaining signal. According to an embodiment, even when the second type corresponding to the second audio source is identified, the third artificial intelligence model may identify the second audio source as the remaining signal if the output value of the second audio signal is smaller than a predetermined value.

FIG. 8 illustrates a second artificial intelligence model according to an embodiment.

Referring to FIG. 8, according to an embodiment, an electronic device (for example, the electronic device 200 of FIG. 2) may include a second artificial intelligence model 800. According to an embodiment, the second artificial intelligence model 800 may be a model trained to output audio sources (or noise signals of at least one type) of at least one noise types (for example, a first noise type, a second noise type, . . . , or an n^{th} noise type) included in the input remaining signal when the remaining signal is input. According to an embodiment, the second artificial intelligence model 800 may be a neural network model implemented as a DNN. According to an embodiment, at least one noise type may include various types including a babble noise type, a white noise type, a wind noise type, or an engine noise type. According to an embodiment, the second artificial intelligence model 800 may be trained to separate and output noise signals of at least one type included in the input audio signal, based on a feature corresponding to each of the noise types.

According to an embodiment, the electronic device may identify noise signals corresponding to at least one type from a first audio signal (for example, the first audio signal of FIG. 3), based on the remaining signal of the first audio signal being input into the second artificial intelligence model 800. According to an embodiment, the electronic device may identify a noise signal corresponding to the white noise type and a noise signal corresponding to the engine noise type included in the first audio signal.

According to an embodiment, even when a second type (for example, the type of FIG. 7) corresponding to a second audio source is identified, the electronic device may identify the second audio source as the remaining signal or include the same in the remaining signal if the output value of the second audio source is smaller than a predetermined value. According to an embodiment, the remaining signal including the second audio source may be input into the second artificial intelligence model 800. The second artificial intelligence model 800 may separate the second audio source having the output value smaller than the predetermined value among the signals included in the remaining signal.

According to the above-described example, the electronic device may classify noise signals of a plurality of different types included in the audio signals as well as main audio sources (for example, the speech type or the music type) included in the audio signals and provide the same to the user. The electronic device may identify not only the audio source of the predetermined type but also the audio source of the predetermined noise type (or the noise signal of the predetermined type) and provide various pieces of information to the user.

FIG. 9 illustrates a method of providing a user interface (UI) according to an embodiment.

Referring to FIG. 9, according to an embodiment, an electronic device (for example, the electronic device 200 of FIG. 2) may provide a UI 910 including information on each of audio sources of the identified at least one type. According to an embodiment, the electronic device may further include a display 900 (for example, the display module 160 of FIG. 1). The electronic device may provide the UI 910 through the display 900.

According to an embodiment, the electronic device may identify audio sources (for example, the audio sources corresponding to at least one type of FIG. 5) corresponding to at least one noise type (for example, the noise types of FIG. 8) corresponding to at least one type from a first audio signal (for example, the first audio signal of FIG. 3). According to an embodiment, the electronic device may identify information on audio sources corresponding to the identified at least one type and information on audio sources corresponding to at least one noise type. According to an embodiment, the information on the audio sources corresponding to at least one type may include information related to the control of output values of the audio sources corresponding to at least one type. According to an embodiment, the information on the audio sources corresponding to at least one noise type may include information related to the control of output values of the audio sources corresponding to at least one noise type.

For example, it is assumed that the first audio signal include an audio source of a user voice type, an audio of a speed type, an audio source of a music type, an audio source of a wind type, and an audio source of a non-classified noise type. The electronic device may provide a UI for guiding the control of the output corresponding to the audio of each of the identified types. For example, a user input corresponding to a button 911 corresponding to the user voice type is received, the UI may include information for controlling an output value corresponding to the user voice type within a predetermined range. According to an embodiment, the UI may include the button 911 corresponding to the user voice type, a button 912 corresponding to the speech type, a button 913 corresponding to the music type, a button 914 corresponding to the wind type, and a button 915 corresponding to the non-classified noise type. The electronic device may change an output value for the audio source, based on a user input corresponding to a button of a different type included in the UI.

According to the above-described example, the electronic device may provide a second audio signal (for example, the second audio signal of FIG. 3), based on a user's demand by providing information on noise signals of various types as well as information on main audio sources (for example, the speech type or the music type) included in the audio signal.

FIG. 10 is a flowchart illustrating a method of identifying a weight according to an embodiment.

Referring to FIG. 10, according to an embodiment, the operation method may identify a first weight (for example, the weight of FIG. 6) corresponding to a first type, based on an output value of a first audio source and an output value of the remaining signal, excluding the first audio source (for example, the audio source of FIG. 6), of a first audio signal (for example, the first audio signal of FIG. 3) in operation 1001.

According to an embodiment, an electronic device (for example, the electronic device 200 of FIG. 2) may identify the first audio source (for example, an audio source of a music type) corresponding to the first type in the first audio signal. According to an embodiment, the electronic device may compare the output value of the first audio signal with the output value of the first audio signal and identify the first weight corresponding to the first type. For example, the first weight may be a ratio of the first audio source to the first audio signal. However, the disclosure is not limited thereto and, for example, the first weight may be a ratio of the first audio source to the remaining signal, excluding the first audio source, of the first audio signal.

According to an embodiment, the operation method may signal-process audio sources corresponding to the identified at least one type, based on the identified weight in operation 1003. According to an embodiment, when the first weight of the first type corresponding to the first audio source is identified, the electronic device may apply the first weight to the first audio source and identify a second audio signal (for example, the second audio signal of FIG. 3), based on the first audio source to which the first weight is applied.

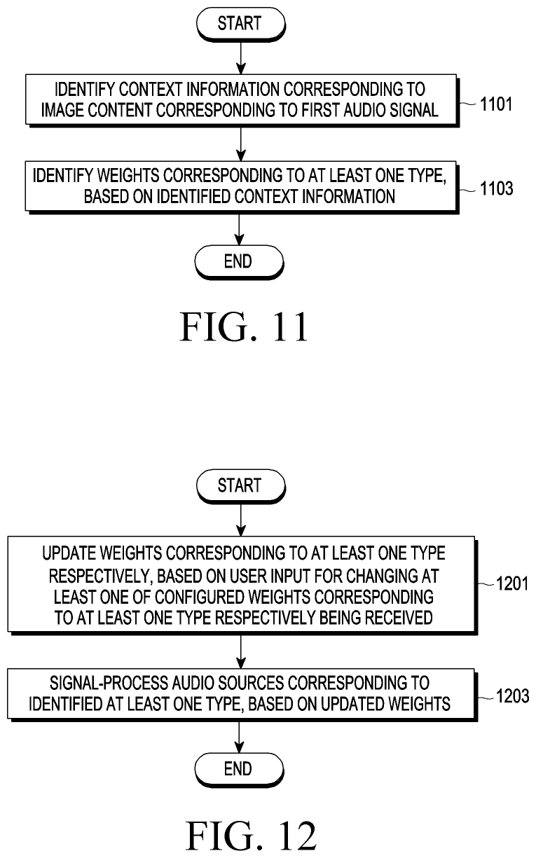

FIG. 11 is a flowchart illustrating a method of identifying a weight according to an embodiment.

Referring to FIG. 11, according to an embodiment, the operation method may identify context information corresponding to video content corresponding to a first audio signal in operation 1101. According to an embodiment, the context information corresponding to the video content may be information on a type corresponding to an object (for example, a person, piano, or the like) included in the video content. According to an embodiment, an electronic device (for example, the electronic device 200 of FIG. 2) may identify the object included in the video content by using a video analysis algorithm for identifying the object included in the video content.

According to an embodiment, the electronic device may identify an audio type corresponding to the identified object. According to an embodiment, information on objects corresponding to at least one type (for example, the types of FIG. 4) may be stored in memory (for example, the memory 130 of FIG. 1). According to an embodiment, a type corresponding to a person may be “speech”. According to an embodiment, a type corresponding to piano may be “music”. For example, when a person and piano are included in the video content, the electronic device may identify the speech type and the music type as context information corresponding to the first audio signal.

According to an embodiment, the electronic device may identify context information corresponding to the video content by using a predetermined video recognition algorithm. For example, when the video content is “content in which children sing”, the electronic device may identify the “speech type” and the “music type” as context information corresponding to the video content.

According to an embodiment, the operation method may identify weights corresponding to at least one type, based on the identified context information in operation 1103. According to an embodiment, when a type corresponding to the video context is identified based on the identified context information, the electronic device may update weights to increase the weight of the audio source corresponding to the identified type. For example, when it is identified that the context information is the speech type and the music type, weights may be updated such that the weights for the audio sources corresponding to the identified speech type and music type increase.

According to an embodiment, the electronic device may update weights to decrease the weights corresponding to audio sources other than the audio sources corresponding to the identified types. For example, when the music type is not identified in the context information, the electronic device may decrease the weight corresponding to the music type.

FIG. 12 is a flowchart illustrating a method of identifying a weight according to an embodiment.

Referring to FIG. 12, according to an embodiment, the operation method may update a weight corresponding to each of at least one type (for example, the types of FIG. 4), based on a user input being received to change at least one of configuration values (for example, the weights of FIG. 3) corresponding to at least one type in operation 1201.

According to an embodiment, an electronic device (for example, the electronic device 200 of FIG. 2) may include an input module (for example, the input module 150 of FIG. 1). According to an embodiment, the electronic device may receive a user input for changing a weight corresponding to each of at least one type through the input module. According to an embodiment, the electronic device may change the weight corresponding to each type, based on the received input. For example, when a user input for increasing a weight of a music type is received, the electronic device may increase the weight corresponding to the music type.

Referring to FIG. 12, according to an embodiment, the operation method may signal-process audio sources corresponding to the identified at least one type, based on the updated weights in operation 1203. According to an embodiment, when the updated weight is identified, the electronic device may signal-process the audio source by applying the identified weight to the corresponding audio source. According to an embodiment, the electronic device may identify a second audio signal (for example, the second audio signal of FIG. 3), based on the signal-processed audio source.

FIG. 13A illustrates a first artificial intelligence model and a third artificial intelligence model according to an embodiment.

Referring to FIG. 13A, according to an embodiment, an electronic device (for example, the electronic device 200 of FIG. 2) may include a first artificial intelligence module 1310 and a third artificial intelligence model 1320. According to an embodiment, when an audio signal is input, the first artificial intelligence model 1310 may be a model trained to separate the input audio signal into at least one audio source. According to an embodiment, the first artificial intelligence model 1310 may be a model trained based on machine learning. According to an embodiment, the first artificial intelligence model 1310 may be trained to separate the audio source, based on a unique feature of each type (for example, the type of FIG. 6). According to an embodiment, types of the audio sources may be various types including a speech type, a music type, an alarm type, or a siren type. According to an embodiment, the first artificial intelligence model 1310 may be implemented as a deep neural network (DNN)-based artificial intelligence model but may be implemented as the DNN and various types of models.

According to an embodiment, the electronic device may input a first audio signal (for example, the first audio signal of FIG. 3) into the first artificial intelligence model 1310 and identify a plurality of audio sources (first audio source, second audio source, . . . , or n^{th} audio source). According to an embodiment, the plurality of audio sources may be an audio signal included in the first audio signal. According to an embodiment, the first artificial intelligence model 1310 may output the remaining signal, excluding the plurality of audio sources, of the first audio signal.

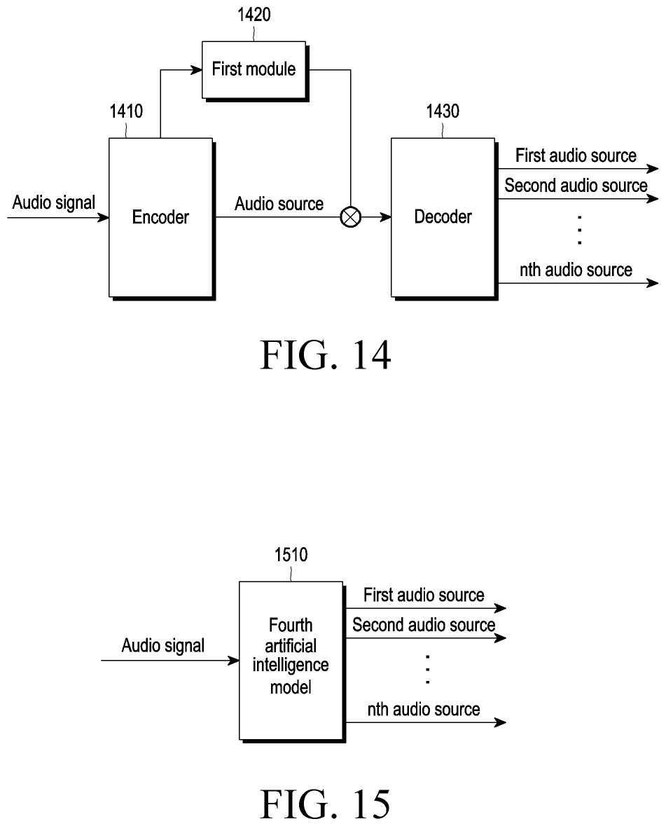

According to an embodiment, the first artificial intelligence model 1310 may be trained to make the size of the input audio signal the same as a sum of sizes of the output audio signals. According to an embodiment, a cost function of the first artificial intelligence model 1310 may include a difference value between the sum of sizes of the output signals and a sum of sizes of input signals. Accordingly, the first artificial intelligence model 1310 may be trained such that the difference value between the sum of sizes of output signals and the sum of sizes of input signals becomes 0. For example, the input signal may be the first audio signal, and the output signal may include a plurality of audio sources, separated from the first audio signal, and the remaining signal. According to an embodiment, the first artificial intelligence model 1310 may be implemented as a model including a plurality of modules or implemented as a single model. This will be described in detail with reference to FIGS. 14 and 15.

According to an embodiment, the first artificial intelligence model 1310 may be a model trained to output audio sources corresponding to at least one type. For example, the first artificial intelligence model 1310 may be model trained to output the audio source of the music type as the first audio source and output the audio source of the speech type as the second audio source.

According to an embodiment, when a plurality of audio sources is input, the third artificial intelligence model 1320 may be a model trained to separate types of input audio signals. According to an embodiment, the electronic device may identify types corresponding to at least one audio source by using the third artificial intelligence model 1320 trained to separate types of the input audio sources. According to an embodiment, the third artificial intelligence model 1320 may be implemented as a classifier. For example, the third artificial intelligence model 1320 may be implemented as a DNN. According to an embodiment, the third artificial intelligence model 1320 may be implemented based on support vector machine (SVM) or various types of algorithms including a linear regression algorithm.

According to an embodiment, when a plurality of audio sources is input, the third artificial intelligence model 1320 may classify the plurality of input audio sources and identify outputs of the classified audio sources, so as to identify types of the audio sources. For example, when the first audio source separated through the first artificial intelligence model 1310 is input into the third artificial intelligence model 1320, the third artificial intelligence model 1320 may identify the type of the first audio source. When it is identified that the output value of the first audio source is smaller than a predetermined value even in the case where the type of the first audio source is identified, the third artificial intelligence model 1320 may identify the first audio source as the remaining signal (for example, the remaining signal of FIG. 3). According to an embodiment, the third artificial intelligence model 1320 may be a model that only classifies the plurality of input audio sources.

According to an embodiment, the third artificial intelligence model 1320 may include the second artificial intelligence model. For example, it may be assumed that the third artificial intelligence model 1320 includes the second artificial intelligence model (for example, the second artificial intelligence model of FIG. 8). When the remaining signal is input along with the plurality of audio sources into the third artificial intelligence model 1320, the third artificial intelligence model 1320 may classify the plurality of audio sources and classify the remaining input signals as noise signals of at least one type. According to an embodiment, the third artificial intelligence model 1320 may be a model implemented as a plurality of classification models. This will be described in detail with reference to FIG. 17.

According to the above-described example, the first artificial intelligence model 1310 may perform a function of separating the audio signal into a plurality of audio sources and the remaining signal, and the third artificial intelligence model 1320 may classify the plurality of audio sources according to corresponding to types or classify the remaining signal into noise signals of at least one type.

FIG. 13B illustrates a method of identifying a second audio signal according to an embodiment.

Referring to FIG. 13B, according to an embodiment, an electronic device (for example, the electronic device 200 of FIG. 2) may include a third artificial intelligence model 1320, an input reception module 1330, a context recognition module 1340, and a mixing module 1350.

According to an embodiment, the input reception module 1330 may be a module for receiving a user input. According to an embodiment, as illustrated in FIG. 9, based on provision of a UI (for example, the UI 910 of FIG. 9) through a display (for example, the display module 160 of FIG. 1), the input reception module 1330 may identify a user input corresponding to audio sources (for example, the audio sources of at least one type of FIG. 3) corresponding to the identified at least one type or noise (for example, the noise signals of FIG. 8) corresponding to at least one type. According to an embodiment, the input reception module 1330 may receive information on types of at least one audio source included in the first audio signal through the third artificial intelligence model 1320. The input reception module 1330 may provide the UI, based on the received information on types.

According to an embodiment, when a user input for controlling an output value corresponding to the audio source or the noise signal of each type is identified through the input reception module 1330, the electronic device may control the output value of each audio source or noise signal, based on the received input. According to an embodiment, the electronic device may identify a relative output value of the audio source or noise signal of each type, based on the received input, and identify a weight, based on the identified relative output value. According to an embodiment, the input reception module 1330 may transmit the identified weight or the identified output value to the mixing module 1350.

According to an embodiment, the context recognition module 1340 may identify context information (for example, the context information of FIG. 11) corresponding to video content from the video content corresponding to a first audio signal (for example, the first audio signal of FIG. 3). According to an embodiment, the context information may be information on a types corresponding to an object (for example, a person, piano, or the like) included in the video content. According to an embodiment, the context recognition module 1340 may identity the type of the object included in the video content by using a video analysis algorithm for identifying the object included in the video content. The context recognition module 1340 may identify context information, based on content of the video content.

According to an embodiment, the context recognition module 1340 may identify weights corresponding to at least one type (for example, the types of FIG. 4), based on the identified context information, and transmit the identified weights to the mixing module 1350. According to an embodiment, the context recognition module 1340 may receive information on types of at least one audio source included in the first audio signal through the third artificial intelligence model 1320. The context recognition module 1340 may identify weights corresponding to at least one type, based on the received information on types and the identified context information.

According to an embodiment, the context recognition module 1340 may transmit the identified context information to the mixing module 1350. In this case, the mixing module 1350 may identify weights corresponding to at least one type, based on the received context information.

According to an embodiment, the mixing module 1350 may receive audio sources of at least one type included in the first audio signal from the third artificial intelligence model 1320. According to an embodiment, the mixing module 1350 may signal-process the audio sources of at least one type and generate, output, or identify a second audio signal. For example, the mixing module 1350 may identify the signal-processed audio sources by applying a configured filter value and a configured weight corresponding to each of the audio sources of at least one type. According to an embodiment, the mixing module 1350 may signal-process the audio sources, based on the weights received from at least one of the input reception module 1330 or the context recognition module 1340. According to an embodiment, the mixing module 1350 may generate, output, or identify the second audio signal by mixing the signal-processed audio sources.

According to an embodiment, the mixing module 1350 may apply the remaining signal (for example, the remaining signal of FIG. 3) and at least one of a configured filter value and configured weight corresponding to the remaining signal and identify the remaining signal-processed signal. According to an embodiment, when a remaining signal including a noise signal of at least one type is received from at least one of the second artificial intelligence model (for example, the second artificial intelligence model of FIG. 8) or the third artificial intelligence model 1320, the mixing module 1350 may generate, output, or identify the second audio signal by applying the configured filter value and the configured weight to the received remaining signal.

FIG. 14 illustrates an implementation example of a first artificial intelligence model according to an embodiment.

Referring to FIG. 14, according to an embodiment, a first artificial intelligence model (for example, the first artificial intelligence model of FIG. 4) may include a plurality of modules 1410, 1420, and 1430. According to an embodiment, the first artificial intelligence model may be a model which encodes an input audio signal (for example, the first audio signal of FIG. 3), masks the encoded audio signal, decodes the masked audio signal, and outputs audio sources of at least one type (first audio source, second audio source, . . . , n^{th} audio source). In this case, the first artificial intelligence model may output the remaining signal (for example, the remaining signal of FIG. 3) along with the audio sources of at least one type.

According to an embodiment, the encoder 1410 may encode the input audio signal. According to an embodiment, the first module 1420 may mask the encoded audio signals with a plurality of masks to separate the audio signal into information corresponding to a plurality of audio sources. According to an embodiment, the masks may be an algorithm (or values output through the algorithm) for estimating magnitude spectra corresponding to the plurality of audio sources included in the audio signal in order to separate the audio signal including the plurality of audio sources. According to an embodiment, the decoder 1430 may decode the plurality of masked sources. According to an embodiment, the first artificial intelligence model may be trained to meet [Equation 1] below.

$${Mask}_{( N + 1 )} = 1 - {\sum }_{n = 1}^{N} {Mask}_{n} \qquad [ Equation 1 ]$$

Referring to [Equation 1], when an input first audio signal is separated into N audio sources according to an embodiment, Maskₙ may be a mask value corresponding to an n^{th} source (or an encoded audio source) included in an n^{th} audio signal. For example, the size of n may be equal to or smaller than N. Mask_{(N+1)} may the remaining signal, excluding the N separated audio sources, of the first audio signal. According to [Equation 1], the first artificial intelligence model may be trained to maintain the size of input signals and the size of output signals by maintaining a sum of all masks as 1 even when the audio signal are separated.

According to an embodiment, in order to perform learning to maintain the size of input signals and the size of output signals, the cost function of the first artificial intelligence model may include

$$Fn ( {\sum }_{n = 1}^{N + 1} {Mask}_{n} - 1 ) .$$

According to an embodiment, Fn(x) is an example of the cost function, and may be implemented in various types of functions such as sigmoid(x), hypertangent(x), exponential(x), and log(x). As the cost function is included, the first artificial intelligence model may be trained such that the sum of all masks becomes close to 1. According to an embodiment, the first artificial intelligence model may be trained through a machine learning scheme.

According to an embodiment, when the audio signal is encoded through the encoder 1410, the first artificial intelligence model may mask the encoded audio signal with masks corresponding to a plurality of sources, decode each of the plurality of masked sources, and separate the audio signal into the plurality of audio sources. In this case, as it is learned that the sum of masks corresponding to the plurality of sources is maintained as 1, the signal loss is not generated during a process of separating the audio signal into the plurality of audio sources.

FIG. 15 illustrates an implementation example of a first artificial intelligence model according to an embodiment.

Referring to FIG. 15, according to an embodiment, a first artificial intelligence model (for example, the first artificial intelligence model of FIG. 4) may be implemented as a fourth artificial intelligence model 1510.

According to an embodiment, the fourth artificial intelligence model 1510 may be a model implemented as a single artificial intelligence model unlike FIG. 14. According to an embodiment, the fourth artificial intelligence model 1510 may be an end-to-end (E2E) model trained to output at least one audio source when audio sources are input. According to an embodiment, the fourth artificial intelligence model 1510 may be a model for outputting audio sources of at least one type (for example, a first audio source, a second audio source, or an n^{th} audio source) when the audio signal is input. In this case, the fourth artificial intelligence model 1510 may output the remaining signal (for example, the remaining signal of FIG. 3) along with audio sources of at least one type.

According to an embodiment, the fourth artificial intelligence model 1510 may be trained to meet [Equation 2] below.

$${Sout}_{N + 1} = Sin - {\sum }_{n = 1}^{N} {Sout}_{n} \qquad [ Equation 2 ]$$

Referring to [Equation 2], according to an embodiment, when an input first audio signal is separated into N audio sources, Soutₙ may be the size of an n^{th} audio signal. For example, the size of n may be equal to or smaller than N. According to an embodiment, Sin may be the size of the input signal. Sout_{N+1} may be the size of the remaining signal, excluding the separated N audio sources, of the input first audio signal. According to [Equation 2], the fourth artificial intelligence model 1510 may be trained to maintain the size of the input signal and the size of the output signal even when the audio signal is separated into a plurality of audio sources.

According to an embodiment, in order to perform learning to maintain the size of input signals and the size of output signals, the cost function of the first artificial intelligence model may include

$$Fn ( {\sum }_{n = 1}^{N + 1} {Sout}_{n} - Sin ) .$$

According to an embodiment, Fn(x) is an example of the cost function, and may be implemented in various types of functions such as sigmoid(x), hypertangent(x), exponential(x), and log(x). As the cost function is included, the fourth artificial intelligence model 1510 may be trained such that difference between the size of the input signal and the size of the output signal becomes close to 0. According to an embodiment, the fourth artificial intelligence model 1510 may be trained through a machine learning scheme.

FIG. 16 illustrates an implementation example of a third artificial intelligence model according to an embodiment.

Referring to FIG. 16, according to an embodiment, a third artificial intelligence model (for example, the third artificial intelligence model 1320 of FIG. 13A) may be a model implemented as a plurality of detection modules 1610, 1620, . . . , 1630. According to an embodiment, the plurality of detection modules 1610, 1620, . . . , 1630 including a first detection module, a second detection module, and an n^{th} detection module may be modules trained to detect audio sources of types corresponding to the respective detection modules. According to an embodiment, a plurality of audio sources separated from the fourth artificial intelligence model 1510 may be input into the plurality of detection modules 1610, 1620, . . . , 1630, respectively.

According to an embodiment, the plurality of detection modules 1610, 1620, . . . , 1630 may be implemented as classifiers. According to an embodiment, for example, each of the plurality of detection modules 1610, 1620, . . . , 1630 may be a neural network model implemented as the DNN. For example, the first detection module 1610 may detect an audio source of a first type (for example, a music type). According to an embodiment, when a first audio source is input, the first detection module 1610 may identify that the first audio source is the audio source of the first type. According to an embodiment, when it is identified that the first audio source is the audio source of the first type, the first detection module 1610 may be a module for outputting (or bypassing) the first audio source to a first output signal 1611.

According to an embodiment, even when it is identified that the type of the input audio source is identified, the plurality of detection modules 1610, 1620, . . . , 1630 may classify the audio source as the remaining signal (for example, the remaining signal of FIG. 3) if the size of the input audio source is smaller than a predetermined value. For example, the second detection module 1620 may be a module for detecting an audio source of a second type (for example, a speech type). Even when the an input second audio source is identified as the second type, the second detection module 1620 may identify the second audio source as the remaining signal (for example, the remaining signal of FIG. 3) if the size of the second audio source is smaller than a first value. According to an embodiment, when the size of the second audio source is larger than or equal to the first value, the second detection module 1620 may output the second audio source to a second output signal 1621. When the size of the second audio source is smaller than the first value, the second detection module 1620 may output the second audio source to the remaining signal (for example, an n^{th} output signal 1631).

According to an embodiment, the third artificial intelligence model may include a second artificial intelligence model (for example, the second artificial intelligence model of FIG. 8). For example, when the n^{th} detection module 1630 is implemented as the second artificial intelligence model, the n^{th} detection module 1630 may be a model trained to output noise signals of at least one type included in the input remaining signal if the remaining signal is input. According to an embodiment, the n^{th} detection module 1630 may be a neural network model implemented as the DNN. According to an embodiment, the noise signals of at least one type (or audio sources of at least one noise type) may include various types including a babble noise type, a white noise type, a wind noise type, or an engine noise type. According to an embodiment, the n^{th} detection module 1630 may be trained to separate and output a noise signal of at least one type included in the input remaining signal, based on a feature corresponding to each of the noise types.

According to an embodiment, the n^{th} detection module 1630 may output together the remaining signals received from detection modules except for the n^{th} detection module 1630. For example, when the signal output from the second detection module 1620 is identified as the remaining signal, the n^{th} detection module 1630 may also output the signal output from the second detection module 1620. According to an embodiment, when the signal output from the second detection module 1620 is identified as the remaining signal, the n^{th} detection module 1630 may classify the signal as one of the noise signals of at least one type. According to an embodiment, the n^{th} output signal 1631 may include at least one audio signal respectively corresponding to the noise signals of at least one type.

In an embodiment, a first artificial intelligence model (for example, the first artificial intelligence model of FIG. 4), the second artificial intelligence model, the third artificial intelligence model, a fourth artificial intelligence model (for example, the fourth artificial intelligence model 1510 of FIG. 15), and a fifth artificial intelligence model described below may be artificial intelligence models included in an electronic device (for example, the electronic device 200 of FIG. 2). According to an embodiment, the first artificial intelligence model, the second artificial intelligence model, the third artificial intelligence model, the fourth artificial intelligence model, and the fifth artificial intelligence model described below may be artificial intelligence models included in an external electronic device (for example, the electronic device 104 of FIG. 1 or the server 108 of FIG. 1). According to an embodiment, data (for example, noise signals of at least one type) output from the artificial intelligence model included in the external electronic device may be transmitted to the electronic device through a communication module (for example, the communication module 190 of FIG. 1).

FIG. 17 illustrates a fifth artificial intelligence model according to an embodiment.

According to FIG. 17, according to an embodiment, an electronic device (for example, the electronic device 200 of FIG. 2) may include a fifth artificial intelligence model 1700. According to an embodiment, the fifth artificial intelligence model 1700 may be a model trained to output a second audio signal (for example, the second audio signal of FIG. 3) when a first audio signal (for example, the first audio signal of FIG. 3) is input. According to an embodiment, the fifth artificial intelligence model 1700 may be a single neural network model implemented to output a second audio signal corresponding to the improved sound quality than the sound quality of the first audio signal by using the first audio signal and predetermined weights when the first audio signal is input.

According to an embodiment, the fifth artificial intelligence model 1700 may be implemented as a machine learning model. According to an embodiment, the fifth artificial intelligence model may be a model trained to reduce difference between a target value of the second audio signal and the output second audio signal after the target value of the second audio signal (for example, an ideal second audio signal) and configured weights (for example, the weights of FIG. 3) are input into labels. Accordingly, a predicted error for the finally output second audio signal may be directly reflected in the model. Further, since the audio source separation operation and the audio source mixing operation are not performed separately, deterioration of the sound quality by a leakage component may be minimized.

According to an embodiment, when weights acquired through the input reception module 1330 and the context recognition module 1340 are input into an embedding model 1710, the embedding model 1710 may perform conversion into embedding corresponding to the weights, based on the input weights. According to an embodiment, the embedding model 1710 may provide the embedding corresponding to the weights to the fifth artificial intelligence model 1700. The fifth artificial intelligence model 1700 may output the second audio signal by using the received embedding. According to an embodiment, the embedding model 1710 may be implemented as a neural network model including a plurality of layers.

FIGS. 18A to 18C illustrate filters according to an embodiment.

Referring to FIGS. 18A to 18C, according to an embodiment, an electronic device (for example, the electronic device 200 of FIG. 2) may signal-process an audio source corresponding to each of at least one type by using a filter (for example, the filter of FIG. 6) corresponding to each of at least one type. Audio sources corresponding to at least one noise type (for example, the noise types of FIG. 8) may be signal-processed.

According to an embodiment, the filter may be implemented as a filter that performs filtering such that an output ratio of a signal corresponding to a predetermined frequency band increases as illustrated in a graph of FIG. 18A. For example, a filter corresponding to a wind noise may be implemented as a filter corresponding to the graph illustrated in FIG. 18A. According to an embodiment, the filter may be implemented as a filter that perform filtering such that an output ratio of a signal in a low-frequency band increases and a signal in a band higher than or equal to a predetermined frequency band is blocked as illustrated in a graph of FIG. 18B. For example, a filter corresponding to an audio source of a user's voice type may be implemented as a filter corresponding to the graph illustrated in FIG. 18B. For example, like a graph illustrated in FIG. 18C, according to an embodiment, the filter may be implemented as a filter corresponding to various proportions for each frequency band. For example, the filter may be a filter that performs filtering such that an output value of the low-frequency band is output with a relatively high proportion compared to an output value of the high-frequency band. In this case, the filter corresponding to the graph illustrated in FIG. 18C may be a filter corresponding to the remaining signal (for example, the remaining signal of FIG. 3).

The electronic device 101 or 200 according to an embodiment of the disclosure may include the memory 130 or 210 configured to store instructions and at least one processor 120 or 220. According to an embodiment, the instructions, when executed by the at least one processor 120 or 220, may cause the electronic device 101 or 200 to identify audio sources, corresponding to at least one type, from a first audio signal including a plurality of audio sources.

According to an embodiment, the instructions may cause the electronic device 101 or 200 to, based on a configuration value corresponding to the at least one type, perform signal processing for the audio source corresponding to the identified at least one type.

According to an embodiment, the instructions may cause the electronic device 101 or 200 to, based on at least a portion of a remaining signal, excluding the identified audio source, of the first audio signal, and the signal-processed audio source, provide a second audio signal.

According to an embodiment, the instructions may cause the electronic device 101 or 200 to, based on the first audio signal input into a first artificial intelligence model 1310, identify at least one audio source included in the first audio signal.

According to an embodiment, the instructions may cause the electronic device 101 or 200 to identify a type corresponding to each of the identified audio source.

According to an embodiment, the first artificial intelligence model 1310 may be trained such that a sum of an output value of the remaining signal and an output value of the at least one audio source is equal to an output value of the first audio signal.

According to an embodiment, the instructions may cause the electronic device 101 or 200 to, based on each of a filter and a weight corresponding to the identified type, perform the signal processing for the identified audio source corresponding to at least one type.

According to an embodiment, the instructions may cause the electronic device 101 or 200 to provide an audio signal, where the at least a portion of the remaining signal and the signal-processed audio source are mixed, as the second audio signal.

According to an embodiment, the instructions may cause the electronic device 101 or 200 to, based on identifying a first type corresponding to a first audio source among the at least one audio source, identify a first audio source filtered through a first filter corresponding to the first type.

According to an embodiment, the instructions may cause the electronic device 101 or 200 to perform signal processing for the first audio source, based on a first weight corresponding to the first type and the filtered first audio source.

According to an embodiment, the instructions may cause the electronic device 101 or 200 to, based on identifying that an output value of a second audio source among the at least one audio source is greater than or equal to a first value, identify a second type corresponding to the second audio source.

According to an embodiment, the instructions may cause the electronic device 101 or 200 to, based on identifying that the output value of the second audio source is less than the first value, identify the second audio source as the remaining signal.

According to an embodiment, the instructions may cause the electronic device 101 or 200 to, based on the remaining signal of the first audio signal input into a second artificial intelligence model 800, identify an audio source corresponding to at least one noise type from the first audio signal.

According to an embodiment, the electronic device 101 or 200 may further include the display 900.

According to an embodiment, the instructions may cause the electronic device 101 or 200 to provide, through the display 900, the user interface (UI) 910 including information about the audio source corresponding to the at least one type and information about the audio source corresponding to the at least one noise type.

According to an embodiment, the instructions may cause the electronic device 101 or 200 to, based on an output value of a first audio source among the at least one audio source and the output value of a remaining signal, excluding the first audio source, of the first audio signal, identify a first weight corresponding to a first type corresponding to the first audio source.

According to an embodiment, the instructions may cause the electronic device 101 or 200 to perform signal processing for the first audio source corresponding to the first type based on the identified weight.

According to an embodiment, the instructions may cause the electronic device 101 or 200 to identify context information corresponding to video content corresponding to the first audio signal.

According to an embodiment, the instructions may cause the electronic device 101 or 200 to, based on the identified context information, identify the weight corresponding to the at least one type.

According to an embodiment, the instructions may cause the electronic device 101 or 200 to identify a third type related to the video content based on the identified context information.

According to an embodiment, the instructions may cause the electronic device 101 or 200 to update the configuration value such that a weight corresponding to the identified third type to be increased and a weight corresponding to a type different from the third type to be decreased.

According to an embodiment, the instructions may cause the electronic device 101 or 200 to update a weight corresponding to each of the at least one type, based on a user input for changing at least one of the configuration values corresponding to the at least one type, respectively, being received.

According to an embodiment, the instructions may cause the electronic device 101 or 200 to signal-process audio sources corresponding to the identified at least one type, based on the updated weight.

A method of operating the electronic device 101 or 200 according to an embodiment of the disclosure may include an operation of identifying audio sources, corresponding to at least one type, from a first audio signal including a plurality of audio sources.

According to an embodiment, the method may include an operation of, based on configured values corresponding to the at least one type, signal-processing the audio sources corresponding to the identified at least one type.

According to an embodiment, the method may include an operation of, based on at least a portion of a remaining signal, excluding the identified audio sources, of the first audio signal, and the signal-processed audio sources, providing a second audio signal.

According to an embodiment, the operation of identifying the audio sources corresponding to the at least one type may include an operation of, based on the first audio signal being input into the first artificial intelligence model 1310, identifying at least one audio source included in the first audio signal.

According to an embodiment, the operation of identifying the audio sources corresponding to the at least one type may include an operation of identifying a type corresponding to each of the identified audio source.

According to an embodiment, the operation of signal-processing may include an operation of, based on each of a filter and a weight corresponding to the identified type, signal-processing the audio sources corresponding to the identified at least one type.

According to an embodiment, the operation of providing the second audio signal may include an operation of providing an audio signal obtained by mixing at least a portion of the remaining signal and the signal-processed audio source, as the second audio signal.

According to an embodiment, the operation of signal-processing may include an operation of, based on a first type corresponding to a first audio source being identified among the at least one audio source, identifying a first audio source filtered through a first filter corresponding to the first type.

According to an embodiment, the operation of signal-processing may include an operation of signal-processing the first audio source, based on a first weight corresponding to the first type and the filtered first audio source.

According to an embodiment, the operation of identifying the type may include an operation of, based on an output value of a second audio source being identified to be larger than or equal to a first value among the at least one audio source, identifying a second type corresponding to the second audio source.

According to an embodiment, the operation of identifying the type may include an operation of, based on an output value of the second audio source being identified to be smaller than the first value, identifying the second audio source as the remaining signal.

According to an embodiment, the method may include an operation of, based on the remaining signal of the first audio signal being input into a second artificial intelligence model 800, identifying audio sources corresponding to at least one noise type from the first audio signal.

According to an embodiment, the method may include an operation of providing the user interface (UI) 910 including information on the audio sources corresponding to the at least one type and information on the audio sources corresponding to the at least one noise type.

According to an embodiment, the operation of signal-processing the audio sources may include an operation of, based on an output value of a first audio source among the at least one audio source and an output value of a remaining signal, excluding the first audio source, of the first audio signal, identifying a first weight corresponding to a first type corresponding to the first audio source.

According to an embodiment, the operation of signal-processing the audio sources may include an operation of signal-processing the first audio source corresponding to the first type, based on the identified weight.

A non-transitory computer-readable medium storing instructions according to an embodiment of the disclosure is provided. The instructions may cause, when executed by at least one processor 120 or 220 of the electronic device 101 or 200, the electronic device 101 or 200 to identify an audio source corresponding to at least one type from a first audio signal including a plurality of audio sources.

According to an embodiment, the instructions may cause the electronic device 101 or 200 to, based on a configuration value corresponding to the at least one type, perform signal processing for the audio source corresponding to the identified at least one type.

According to an embodiment, the instructions may cause the electronic device 101 or 200 to, based on at least a portion of a remaining signal, excluding the identified audio source, of the first audio signal, and the signal-processed audio source, provide a second audio signal.

Effects that can be acquired by the disclosure are not limited to the above-mentioned effects, and other effects that have not been mentioned may be clearly understood by those skilled in the art to which the disclosure belongs.

As used herein, the term “if” may be construed to mean “when” or “upon”, “in response to determining”, or in response to detecting” depending on the context. Similarly, the phrase “if it is determined” or “if [a stated condition or event] is detected” may be selectively construed to mean “upon determining”, “in response to determining”, “upon detecting [the stated condition or event]”, or “in response to detecting [the stated condition or event]” depending on the context.

The above-described device may be implemented as a hardware component, a software component, and/or a combination of the hardware component and the software component. For example, the devices and components described in the embodiments may be implemented using one or more computers including components such as a processor, a controller, an arithmetic logic unit (ALU), a digital signal processor, a microcomputer, a field programmable gate array (FPGA), a programmable logic unit (PLU), a microprocessor, or any other device capable of executing instructions and responding thereto. A processing device (or a processing circuit) may execute an operating system (OS) and one or more software applications executed on the operating system. Further, the processing device may access, store, control, process, and generate data in response to the execution of software. For convenience of understanding, it is described in certain examples that one processing device is used, but those skilled in the art may understand that the processing device may include a plurality of processing elements and/or a plurality of types of processing elements. For example, the processing device may include a plurality of processors or one processor and one controller. In addition, other processing configurations such as a parallel processor may be implemented.

The software may include a computer program, code, instructions, or a combination of one or more thereof, and may configure the processing device, or instruct the processing device independently or collectively to operate as desired. Software and/or data may be interpreted by the processing device or, in order to provide instructions or data to the processing device, may be embodied in any type of machine, component, physical device, or computer storage medium or device. The software may be distributed over computer systems connected through the network and stored or executed in a distributed manner The software and data may be stored in one or more computer-readable recording media.

The method according to the embodiments may be implemented in the form of program instructions that can be executed through various computer means and recorded in a computer-readable medium. The medium may continuously store a computer-executable program or may temporarily store the same for execution or download. Further, the medium may be various types of recording means or storage means in the form of a single hardware component or a combination of several hardware components, and may exist in a distributed form on the network without being limited to a medium directly accessing any computer system. Examples of the medium may include magnetic media such as hard disks, floppy disks, and magnetic tapes, optical recording media such as CD-ROM and a DVD, magneto-optical media such as floptical disks, and ROM, RAM, and flash memory, which are configured to store program instructions. Other examples of the medium may be app stores that circulate applications, sites that supply or circulate various other software components, or recording media or storage media that are managed by a server.

As described above, although the embodiments have been described with reference to the limited embodiments and drawings, those skilled in the art can make various modifications and variations, based on the above description. For example, even when the described techniques are performed in the order different from the method described above, and/or even when the components of the system, structure, device, and circuit are coupled or combined in a form different from the way described above, or replaced with or substituted by other components or equivalents, an appropriate result can be achieved.

Therefore, other implementations, other embodiments, and equivalents to the claims belong to the claims described below.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
memory storing instructions; and
at least one processor;
wherein the instructions, when executed by the at least one processor, cause the electronic device to:
identify a first audio signal comprising a plurality of audio sources;
identify a first audio source, corresponding to at least one type, from the first audio signal;
based on at least one configuration value corresponding to each of the at least one type, perform signal processing on the first audio source;
generate a second audio signal based on at least a portion of a remaining signal of the first audio signal excluding the first audio source, and the signal-processed first audio source; and
output the second audio signal.

2. The electronic device of claim 1, wherein, to identify the first audio source, the instructions, when executed by the at least one processor, further cause the electronic device to:
based on the first audio signal being input into a first artificial intelligence model, identify at least one second audio source included in the first audio signal;
identify a type corresponding to each of the at least one second audio source; and
identify the first audio source corresponding to the at least one type,
wherein the first artificial intelligence model is trained such that a sum of a first output value of the remaining signal and a second output value of the at least one second audio source is equal to a third output value of the first audio signal.

3. The electronic device of claim 1, wherein, to perform signal processing on the first audio source, the instructions, when executed by the at least one processor, further cause the electronic device to:
obtain a signal-processed audio source by performing the signal processing on the first audio source based on each of a filter and a first weight corresponding to the at least one type, and
wherein the second audio signal is generated by mixing the at least a portion of the remaining signal and the signal-processed audio source.

4. The electronic device of claim 3, wherein, to perform signal processing on the first audio source, the instructions, when executed by the at least one processor, further cause the electronic device to:
based on identifying a first type corresponding to a first audio source from among the at least one second audio source, obtain a first filtered audio source by filtering the first audio source via a first filter corresponding to the first type; and
perform the signal processing on the first filtered audio source based on a first weight corresponding to the first type and the first filtered audio source.

5. The electronic device of claim 2, wherein the instructions, when executed by the at least one processor, further cause the electronic device to:
based on identifying that a fourth output value of a third audio source from among the at least one second audio source is greater than or equal to the first value, identify a fourth type corresponding to the third audio source; and
based on identifying that the fourth output value is less than the first value, identify the third audio source as the remaining signal.

6. The electronic device of claim 2, wherein the instructions, when executed by the at least one processor, further cause the electronic device to:
based on the remaining signal being input into a second artificial intelligence model, identify a third audio source, from the remaining signal, corresponding to at least one noise type.

7. The electronic device of claim 6, wherein the electronic device further comprises a display, and
wherein the instructions, when executed by the at least one processor, further cause the electronic device to:
output, via the display, a user interface (UI) including information about the first audio source and information about the third audio source.

8. The electronic device of claim 1, wherein the instructions, when executed by the at least one processor, further cause the electronic device to:
based on an output value of the first audio source from among the plurality of audio sources and an output value of the remaining signal, identify a first weight corresponding to a first type corresponding to the first audio source; and
perform the signal processing on the first audio source based on the first weight.

9. The electronic device of claim 1, wherein the instructions, when executed by the at least one processor, further cause the electronic device to:
identify context information corresponding to video content, wherein the video content corresponds to the first audio signal; and
based on the context information, identify a first weight corresponding to the at least one type.

10. The electronic device of claim 9, wherein the instructions, when executed by the at least one processor, further cause the electronic device to:
identify a second type related to the video content based on the context information; and
increase a second weight corresponding to the second type, and decrease a third weight corresponding to a third type different from the second type.

11. The electronic device of claim 3, wherein the instructions, when executed by the at least one processor, further cause the electronic device to:
update a plurality of weights corresponding to the at least one type respectively, based on a user input being received for changing at least one of the at least one configuration value corresponding to the at least one type; and
perform the signal processing on the first audio sources, based on the updated plurality of weights.

12. A method of operating an electronic device, the method comprising:
identifying a first audio signal comprising a plurality of audio sources;
identifying a first audio source corresponding to at least one type from the first audio signal;
based on at least one configuration value corresponding to each of the at least one type, signal-processing on the first audio source;
generating a second audio signal based on at least a portion of a remaining signal of the first audio signal, excluding the first audio source, and the signal-processed first audio sources; and
outputting the second audio signal.

13. The method of claim 12, wherein the identifying the first audio source comprises:
based on the first audio signal being input into a first artificial intelligence model, identifying at least one second audio source included in the first audio signal; and
identifying a type corresponding to each of the at least one second audio source, and
identifying the first audio source corresponding to the at least one type,
wherein the first artificial intelligence model is trained such that a sum of a first output value of the remaining signal and a second output value of the at least one second audio source is equal to a third output value of the first audio signal.

14. The method of claim 12, wherein the performing signal processing comprises, each of a filter and the first weight, obtaining a signal-processed audio source by performing the signal-processing on the first audio source based on each of a filter and a first weight corresponding to the at least one type; and
wherein the second audio signal is generated by mixing at least a portion of the remaining signal and the signal-processed audio source.

15. The method of claim 14, wherein the performing the signal processing comprises:
based on identifying a first type corresponding to a first audio source from among the at least one second audio source, obtaining a first filtered audio source by filtering the first audio source via a first filter corresponding to the first type; and
processing the first filtered audio source, based on a first weight corresponding to the first type and the first filtered audio source.

16. The method of claim 13, wherein the identifying the at least one second type comprises:
based on identifying that a fourth output value of a third audio source from among the at least one second audio source is greater than or equal to a first value, identifying a fourth type corresponding to the third audio source; and
based on identifying that the fourth output value is less than the first value, identifying the third audio source as the remaining signal.

17. The method of claim 13, further comprising, based on the remaining signal being input into a second artificial intelligence model, identifying a third audio source, from the remaining signal, corresponding to at least one noise type.

18. The method of claim 17, further comprising outputting, via a display of the electronic device, a user interface (UI) comprising information about the first audio source and information about the third audio source.

19. The method of claim 12, wherein performing the signal processing comprises:
based on an output value of the first audio source from among the plurality of audio sources and an output value of the remaining signal, identifying a first weight corresponding to a first type corresponding to the first audio source; and
processing the first audio source based on the first weight.

20. A non-transitory computer readable medium storing instructions that, when executed by at least one processor of an electronic device, cause the electronic device to:
identify a first audio signal comprising a plurality of audio sources;
identify a first audio source, corresponding to at least one type, from the first audio signal;
based on at least one configuration value corresponding to each of the at least one type, perform signal processing on the first audio source;
generate a second audio signal based on at least a portion of a remaining signal of the first audio signal excluding the first audio source, and the signal-processed first audio source; and
output the second audio signal.
